(19) United States
(12) Patent Application Publication
(10) Pub. No.: US 2010/0235015 A1
(43) Pub. Date: Sep. 16, 2010

(54) CONTROL ARCHITECTURE AND INTERFACING METHODOLOGY FOR COCKPIT CONTROL PANEL SYSTEMS

(75) Inventor: Jie Jay Chang, Thousand Oaks, CA (US)

Correspondence Address: DYKEMA GOSSETT PLLC, 39577 WOODWARD AVENUE, SUITE 300, BLOOMFIELD HILLS, MI, 48304-5086, US

(73) Assignee: Eaton Corporation, Cleveland, OH (US)

(21) Appl. No.: 12/402,049

(22) Filed: Mar. 11, 2009

(51) Int. Cl. G06F 17/00

(52) U.S. Cl. 701/1; 701/3

(57) ABSTRACT

A hardware-based control and communication architecture communicates a plurality of signals within a vehicle. The communication architecture has a transmitting portion including a signal receiving portion configured to obtain or receive a first plurality of signals, a signal consolidation circuit, a signal driver capable of transmitting a consolidated signal representative of the first plurality of signals from the signal consolidation circuit, and a clock signal generator configured to provide a synchronizing timing signal having an established or fixed period. The signal consolidation circuit may include hardware logic to provide successive data transmission windows based on the established or fixed period of the timing signal, and the consolidation circuit may be configured to transmit each of the first plurality of signals in successive data transmission windows. Bidirectional and redundant system configurations are also disclosed with a plurality of transmission mediums. This new approach may be used to reduce the number of electrical cables over distance within an aircraft or vehicle, thus reducing the weight and size.

### BACKGROUND

1. Technical Field

The present disclosure relates generally to control architectures, interfacing methodologies, and communication system configurations for use in aircraft cockpit control panel systems and vehicle instrumentation and control.

2. Description of the Related Art

As aircraft design has evolved over time, manufacturers have attempted to employ various strategies to reduce or remove weight from airplanes without affecting airplane safety or stability. Throughout much of this history, the U.S. Federal Aviation Administration (FAA) has required airplane manufacturers and component suppliers to submit their designs and prototypes to rigorous testing to prove that concepts used to increase efficiency or performance are sufficiently safe and reliable.

In attempting to reduce or remove weight, aircraft designers have used advanced technologies and designs to replace high weight components and subsystems within the aircraft. There has also been a move to lighter materials. Despite such great efforts to reduce structural weight, the industry has been slow to employ new, weight saving technology when it pertains to flight deck or cockpit panel control systems. One of the heaviest such legacy systems remains the aircraft's wiring architecture, which often uses copper wires in a point-to-point connectivity scheme.

The current state of the art for aircraft wiring employs dedicated wires to individually connect controls in the cockpit control panel with various sensors and actuators or other electrical load devices located elsewhere in the aircraft. Such designs often require complex wiring schemes involving hundreds of wires that must be routed over long distances from a crowded cockpit area. These wiring schemes may add significant weight to the aircraft, and increase service and manufacturing complexity.

In other industries, problems associated with routing multiple wires have been addressed by networking signal communication lines from an originating location to a destination location, thus reducing redundant lengths of cable. These networking techniques often include modern computing technology employing various physical transmission hardware and communication software. Examples of such networking may include using devices that implement the Controller Area Network (“CAN”) 2.0 networking method/protocol, authored by Robert Bosch GmbH, or by using other serial-based devices/protocols.

However, given the current United States vehicle regulatory framework, such as that imposed by the U.S. Federal Aviation Administration, conventional networking methods have not gained universal acceptance. This avoidance of conventional networking is in part due to the requirement that hardware-software systems must generally obtain separate hardware and software certification. This dual certification requirement tends to add both time and cost to the development process. Among other things, the present disclosure attempts to reduce development time and vehicle weight by networking various cockpit control or communication signals with a generally hardware-only communication architecture.

### SUMMARY

A control and communication architecture for communicating a plurality of signals within a vehicle, such as an aircraft, is provided. In an embodiment, the architecture is configured to communicate the plurality of signals without need for traditional architecture components such as microprocessors, digital signal processors (DSPs), etc. In an embodiment, the architecture includes a transmitting portion having a signal receiving portion capable of receiving a first plurality of signals, a signal consolidation circuit, a signal driver capable of transmitting a consolidated signal representative of the first plurality of signals from the electrical signal consolidation circuit, and a clock signal generator capable of generating or providing a synchronizing timing signal having an established or fixed period. In this embodiment, the electrical signal consolidation circuit uses hardware logic to provide successive data transmission windows according to the established or fixed period of the timing signal, where the consolidation circuit is configured to transmit each of the first plurality of signals successively in a data transmission window.

In an embodiment, the architecture may further include a receiving portion having input circuitry configured to obtain or receive the consolidated signal representative of the first plurality of signals, a signal restoring circuit, and a signal output portion configured to transmit a second plurality of signals representative of the consolidated signal from the signal restoring circuit. In this embodiment, the signal restoring circuit includes hardware logic and the established or fixed period of the timing signal to assemble or configure the second plurality of signals to be representative of the first plurality of signals.

In further embodiments, the communication architecture may be used in aircraft applications to communicate at least one avionic signal from a source. Additionally, the signal transmitting portion may be operative to transmit the consolidated signal through any transmission medium, including, without limitation, conductive wire or fiber optic cable.

### BRIEF DESCRIPTION OF THE DRAWINGS

The present invention will now be described, by way of example, with reference to the accompanying drawings, wherein like reference numerals identify like components in the several figures, in which:

FIG. 1 is a schematic block diagram generally illustrating an embodiment of a vehicle control architecture and interfacing methodology;

FIG. 2 is a schematic block diagram generally illustrating an embodiment of a vehicle control architecture and interfacing methodology;

FIG. 3 is a schematic block diagram generally illustrating an embodiment of a vehicle control architecture and interfacing methodology;

FIG. 4 is a schematic diagram generally illustrating an embodiment of a vehicle control architecture and interfacing methodology employing bidirectional data flow;

FIG. 5 is a schematic block diagram generally illustrating an embodiment of a vehicle control architecture and interfacing methodology employing redundant data paths.

FIG. 6 is a schematic block diagram generally illustrating an embodiment of a vehicle control architecture and interfacing methodology employing mixed transmission media forms.

### DETAILED DESCRIPTION

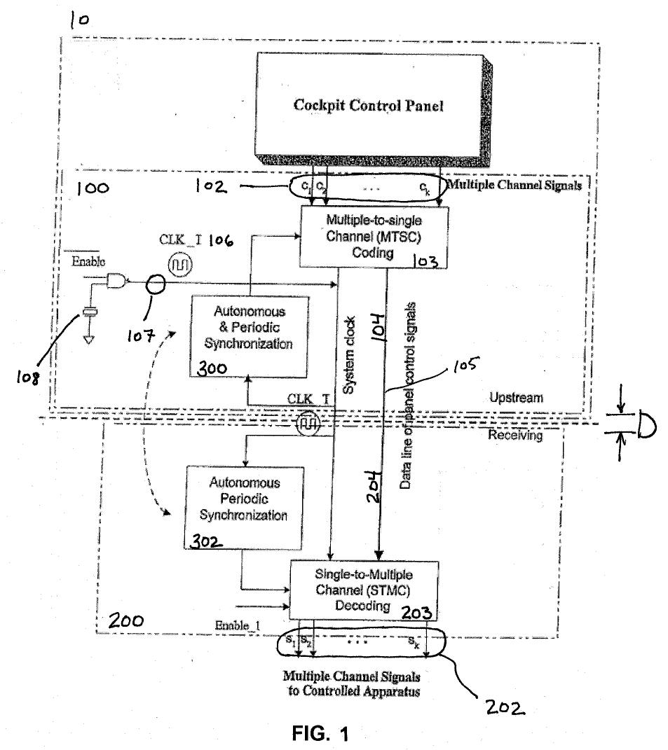

Referring now to the drawings, FIG. 1 generally illustrates an embodiment of a control and communication architecture 10. The architecture 10 includes both a transmitting portion 100 and a receiving portion 200. The transmitting portion 100 is generally intended to obtain a plurality of signals 102 from one or more sources, such as, for example, a cockpit control panel, consolidate the plurality of signals 102 into a single data signal 104 using a multiple to single channel coding device (“MTSC”) 103, and transmit the consolidated data signal 104 across a distance D to a receiving portion 200 on a transmission medium 105. The transmission medium 105 may be, by way of example and not of limitation, a wire such as an electrically conductive copper wire, a fiber optic line, or other medium configured to carry one or more data signals. The receiving portion 200 is generally configured to receive such consolidated data signal 204, restore the signal to its constituent components 202 using a single to multiple channel decoding device (“STMC”) 203, and transmit respective constituent components 202 on to target elements. The received consolidated data signal 204 may be identical or substantially similar to the transmitted consolidated data signal 104. A substantially similar data signal contemplates that for some applications, intermediate signal conditioning circuitry, signal boosting circuitry, signal repeaters, or the like (not pictured), may be employed, such as along the transmission medium 105, and such components may alter the form or power of such signal without essentially altering the content.

It is noted that throughout this description, airplanes and the airline industry are referenced for exemplary purposes. However, it is contemplated that elements and features presented herein may be generally applicable to other types of vehicles, such as, for example, automobiles, motorcycles, motor scooters, or marine vessels.

In an embodiment, the transmitting portion 100 may be placed in or near a user control panel, such as, for example an aircraft cockpit control panel. In such an embodiment, the transmitting portion 100 may receive/obtain a plurality of signals 102 that are representative of user input to the system. Such input may include, without limitation, the actuation of buttons, switches, or levers that are intended to control operational aspects of systems within or throughout an airplane. In an aircraft, these systems may include, by way of example and not limitation, motorized systems such as landing gear control or flap control, engine operation, and interior/exterior lighting control. Furthermore, the receiving portion 200 may then be remotely provided in or near one or more systems that are intended to be controlled.

A transmitting portion 100 may also be placed in or near one or more systems designed to generate feedback signals. In such an embodiment, the transmitting portion 100 may receive a plurality of signals 102 that may be representative of the operating status of the system. Such operating status may include, by way of example and not limitation, alarm conditions, sensor outputs, mechanism or motor positioning, indications of whether a system is on/off, or various other forms of feedback. In an extended implementation, the plurality of signals 102 may comprise analog signals, digital signals, or a combination of analog and digital signals. A corresponding receiving portion 200 may then be placed in or near the user control panel so that a user may be informed of the operating status of the one or more systems.

In addition to the consolidated data signal 104, the vehicle communication architecture 10 may include a synchronizing timing signal 106. Timing signal 106 may be generated by a clock signal generator 108, which may include, for example, a crystal or resonator. Timing signal 106 may have a fixed period, or variable period. Timing signal 106 may be used by transmitting portion 100 and receiving portion 200 for consolidating and restoring the original signals in a synchronous or near synchronous manner. A timing signal 106 may be transmitted to coding device 103 and/or decoding device 203 along transmission medium 107 which may be, by way of example and not of limitation, a wire, such as a copper wire, a fiber optic line, etc. In one embodiment, timing signal may have a frequency less than about 1 MHz, thereby reducing signal noise.

FIG. 1 further illustrates a vehicle control architecture 10 comprising synchronizing circuits 300, 302. Synchronizing circuits 300, 302 may be configured to automatically and periodically re-initialize the cycling of MTSC 103, and STMC 203, respectively.

Synchronizing circuits 300, 302 may receive a timing signal 106 from clock signal generator 108 to effectuate a periodic re-initialization after the associated circuit 300, 302 has accumulated a fixed number of timing signal cycles. In an embodiment, the synchronizing circuit 300, 302 outputs a signal to the MTSC 103, and/or STMC 203, indicating a “RESET” condition after a fixed number timing signals 106 have been received and accumulated. In an embodiment, the synchronizing circuit 300, 302 may include a periodic interrupt timer. Moreover, for some applications, the synchronizing circuit 300, 302 may include multiple counters in series such that the frequency of the re-initializations is reduced. For example, two eight-bit counters may be used in series to form a 16-bit counter, thus providing an extended time period between each reset trigger. In such an example, 65536 cycles of the timing signal 106 might occur prior to synchronizing circuit 300 or 302 effectuating a re-initialization of MTSC 103 or STMC 203. Other methods of creating a “RESET” condition based on monitoring a timing signal 106 are also contemplated herein.

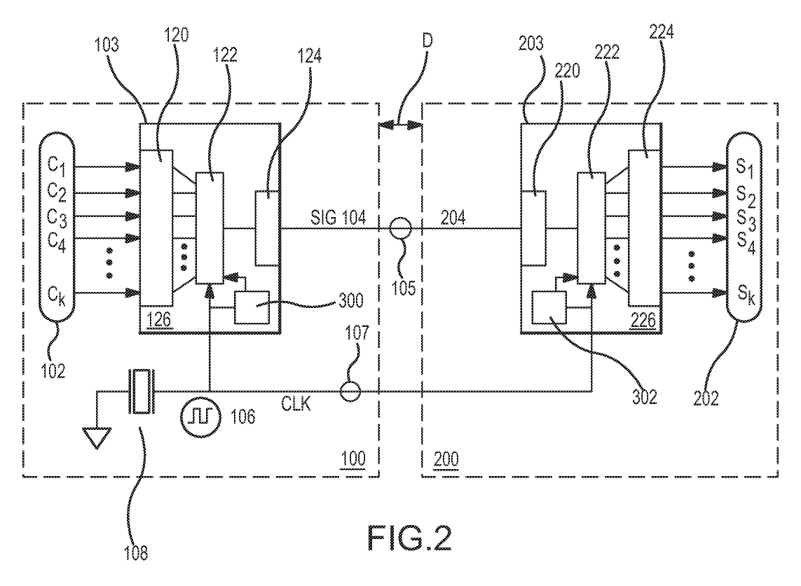

FIG. 2 illustrates the vehicle control and communication architecture 10 of FIG. 1, further depicting an exemplary implementation of MTSC 103 and STMC 203, as well as other signal processing methodology in this scheme.

MTSC 103 may include an electrical receiving portion 120 for receiving/obtaining a plurality of signals 102, an electrical signal consolidation component or circuit 122 for providing a consolidated signal 104 representative of the plurality of signals 102, and a signal driver 124 for transmitting the consolidated signal 104 along transmission medium 105. STMC 203 may include input circuitry 220 configured to receive a consolidated signal 204 over transmission medium 105, a signal restoring circuit 222 for restoring constituent components 202 from the consolidated signal 204, and an electrical signal output portion 224.

Electrical receiving portion 120, consolidation circuit 122 and signal driver 124 may be incorporated in an integrated circuit 126. In another embodiment, the electrical receiving portion 120, consolidation circuit 122 and signal driver 124 may be implemented using discrete components, or a combination of discrete components and integrated circuits. Likewise, the STMC 203 input circuitry 220, restoring circuit 222, and output portion 224 may be implemented via a single integrated circuit 226, using discrete components, or using a combination of discrete components and integrated circuits.

As the plurality of signals 102 are provided, the signals 102 are received or acquired by the input circuitry of electrical receiving portion 120. Input circuitry may include circuitry designed to sample and hold input signals 102, to request and store digital values in a transmission register, to isolate consolidation circuitry, to scale or offset input voltages, and/or perform other sensory input functions. Ultimately, the circuitry of electrical receiving portion 120 may make the input signals 102 available for a signal consolidation circuit 122.

Signal consolidation circuit 122 may include hardware logic configured to consolidate a plurality of input signals 102 into a consolidated signal 104 according to a desired or fixed methodology. Such methodology may use the period of timing signal 106 to define successive data transmission windows, where each of the plurality of input signals 102 are successively transmitted within a separate data transmission window. In an embodiment, the circuitry of the signal consolidation circuit 122 may monitor the timing signal 106 to, for example, increment a ring counter for each successive cycle or half cycle of the repeating timing signal 106. Based on, for example, the output of the incrementing counter, the hardware logic of the signal consolidation circuit 122 may then be configured to cycle through each of the plurality of input signals 102 in a defined or predetermined order to successively transmit each input signal 102 to the driving circuitry 124.

Following consolidation of the plurality of input signals 102 into a consolidated signal 104, signal driving circuitry 124 may transmit such a consolidated signal 104 over a distance D via transmission medium 105 to the receiving portion 200. In an embodiment, the signal driving circuitry 124 may include a fiber optic transmitter that transmits the consolidated signal 104 over a fiber optic transmission medium 105. In another embodiment, the signal driving circuitry 124 may include an electrical power circuit to transmit the consolidated signal 104 over an electrically conductive medium 105, such as a copper wire.

Signal consolidation circuit 122 may be configured to receive input from synchronizing circuit 300, to effectuate a periodic re-initialization of the consolidation circuit 122 after the synchronizing circuit 300 has accumulated a fixed number of timing signals 106.

The input circuitry 220 of the receiving portion 200 may receive a consolidated signal 204 that may be identical or substantially identical to the consolidated signal 104 transmitted by the driving circuitry 124 over transmission medium 105. In an embodiment, the input circuitry 220 may include components or circuitry, such as isolation amplifiers or transformers, configured to isolate the actual consolidated signal 204 from the remainder of the receiving portion 200. Further, if the transmission medium 105 includes non-electrical transmission means, such as fiber optic signal transmission, the input circuitry 220 may include a receiver designed to convert such signal 204 into a corresponding electrical signal. The resulting output of the input circuitry 220 may then be passed on to a signal restoring circuit 222.

From a functional perspective, the signal restoring circuit 222 may generally perform the opposite task of the signal consolidation circuit 122. In an embodiment, the signal restoring circuit 222 obtains the consolidated electrical signal from the input circuitry 220, along with an associated timing signal 106. The signal restoring circuit 222 may use an incrementing counter, such as a ring counter, or other suitable hardware logic to successively cycle through each of a plurality of output channels in synchronization or rhythm with the segmented nature of the consolidated signal 204 and timing signal 106. As an output is generated on each successive channel, the electrical signal output circuitry 224 may then latch each respective output signal until the counter recycles, and the channel is again updated with a subsequent signal. In another embodiment, if the system 10 is configured for transmission of digital signals within each successive data transmission window, electrical signal output circuitry 224 may include a register, or combination of logic devices, to store and make the transmitted digital value available upon receipt.

Signal restoring circuit 222 may be configured to receive input from synchronizing circuit 302, to effectuate a periodic re-initialization of the signal restoring circuit 222 after the synchronizing circuit 302 has accumulated a fixed number of timing signals 106. Synchronizing circuit 302 may be identical or substantially identical to synchronizing circuit 300. Substantially identical is intended to mean that synchronizing circuit 302 may effectuate a similar function as synchronizing circuit 300, though through a different hardware function. Additionally, the synchronizing circuit 302 may be configured to account for varying transmission delays or signal transmission methods.

In an embodiment, synchronizing circuit 302 may be configured to operate in tandem with synchronizing circuit 300 to re-initialize both the signal consolidation circuit 122 and the signal restoration circuit 222 upon the reception of the same cycle of the timing signal 106. In performing a coordinated reset/re-initialization, the system may provides an extra measure of safety by ensuring that any errors or timing discrepancies that may occur within the system are limited in duration. Synchronizing circuits 300, 302 may be implemented using integrated circuits, such as integrated circuits 126, 226, or through any combination of discrete components and integrated circuits that have electrical connectivity with the MTSC/STMC devices 103/203.

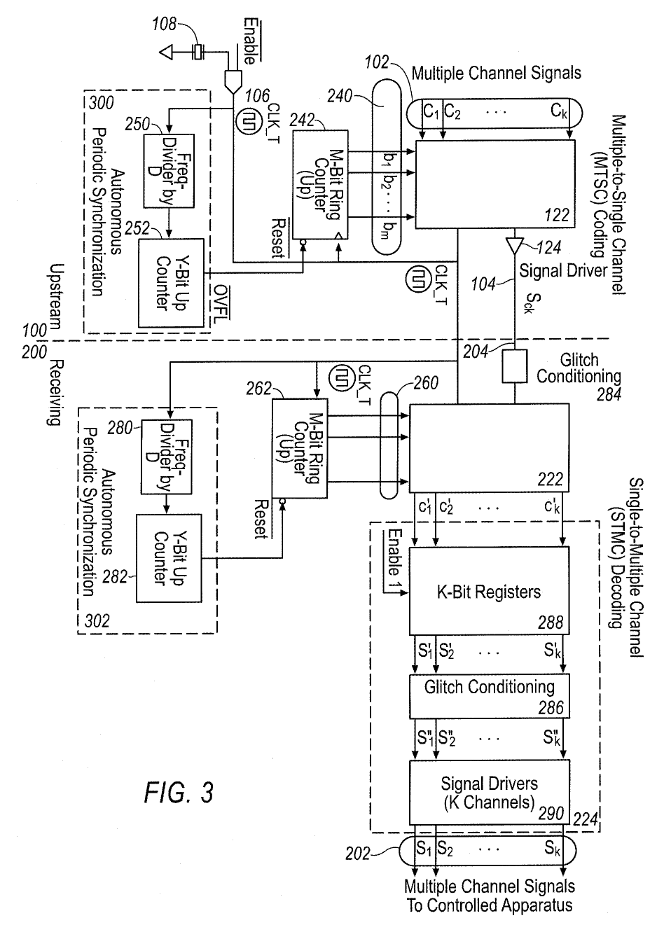

FIG. 3 generally illustrates an embodiment of a block diagram illustrating signal processing flow within the vehicle control architecture 10 of FIG. 2.

In an embodiment, the signal consolidation circuit 122 may be configured to accept the output 240 of hardware logic 242, which may be, for example, a multi-bit ring counter. The hardware logic 242 may be configured to increment the output signal 240 on each successive cycle or half cycle of the repeating timing signal 106. Based on, for example, the output of the hardware logic 242, the signal consolidation circuit 122 may then be configured to cycle through each of the plurality of input signals 102 in a defined or predetermined order to successively transmit each input signal 102 to the driving circuitry 124.

Synchronization circuit 300 may be configured to accept timing signal 106, and using a configuration of frequency dividers 250 and/or multi-bit counters 252, provide an automatic and periodic reset signal to the consolidation circuit 122. In an embodiment, the reset signal is provided by triggering a reset condition on the hardware logic 242 that is used as a basis of the consolidation methodology.

In an embodiment, signal restoring circuit 222 may be configured to accept the output 260 of hardware logic 262. Hardware logic 262 may be, for example, a multi-bit ring counter or other logic, which may operate similar to hardware logic 242 used in the transmitting portion 100.

Synchronization circuit 302 may be configured to accept timing signal 106, and using a configuration of frequency dividers 280 and/or multi-bit counters 282, provide an automatic and periodic reset signal to the restoration circuit 222. In an embodiment, the reset signal is provided by triggering a reset condition on the hardware logic 262 that is used as a basis of the restoration methodology.

In an embodiment, receiving portion 200 may include glitch conditioning 284 prior to the signal restoration circuit 222. In a further embodiment, receiving portion 200 may include glitch conditioning 286 in the electrical signal output circuitry 224. Glitch conditioning 284, 286 may include statistical based error compensation, frequency based error reduction, such as de-bouncing or filtering, or other hardware-based glitch conditioning/reduction methods. Electrical signal output circuitry 224 may further include storage registers 288 and signal drivers 290. In an embodiment, storage registers 288 may be configured for storing only a single bit per output channel, or may be alternatively configured for multi-bit or multi-byte data storage.

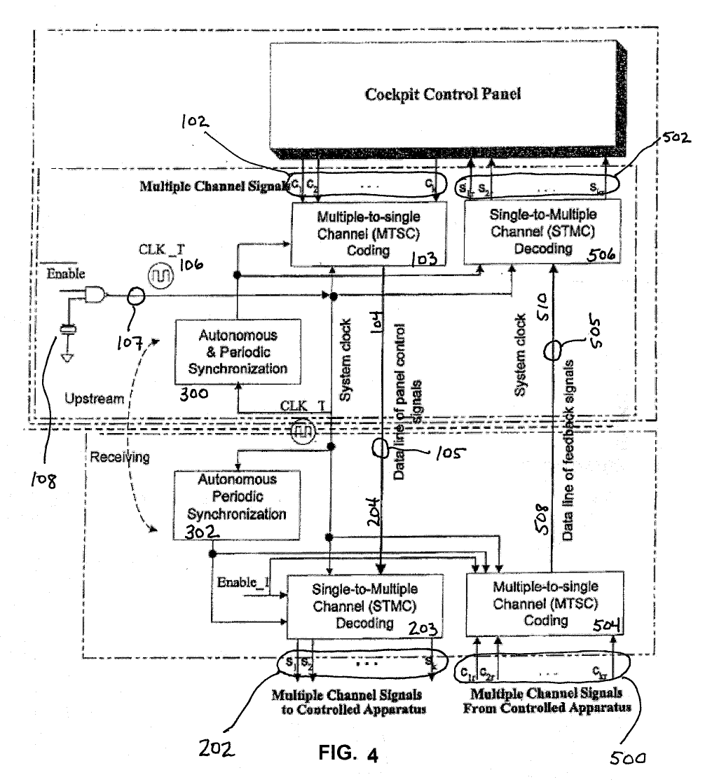

As generally shown in FIG. 4, in an embodiment, the system architecture 10 may include additional circuitry to allow for bidirectional transmission of signals between a user control interface, such as a cockpit control panel, and one or more controlled apparatus or aircraft loads. The architecture 10 includes a first MTSC 103 configured to consolidate a plurality of signals 102 and transmit a consolidated signal 104 to a first STMC 203. The first MTSC 103 may transmit a consolidated signal 104 to the first STMC 203 over a transmission medium 105 in a manner similar to that discussed above with respect to FIGS. 1-3. The vehicle architecture 10 may further include a second MTSC 504. MTSC 504 may be configured to receive a plurality of signals 500 from controlled apparatus (not pictured). Signals 500 may indicate, for example, certain feedback or operational states of the apparatus. The plurality of signals 500 may be converted into a consolidated signal 508 using the timing signal 106 together with the circuitry of the second MTSC coding device 504. MTSC 504 may be similar in design to MTSC 103. The consolidated signal 508 may then be transmitted across a distance D to a second STMC 506 over a transmission medium 505. STMC 506, which may be proximate a user control interface, such as an aircraft cockpit control panel, may receive a signal 510, representative of the plurality of signals 500. Signal 510 may be the same as, or substantially similar to, transmitted consolidated signal 508. Using the timing signal 106 and the circuitry of STMC 506, the system may restore constituent components of consolidated signal 510 into a plurality of signals 502, representative of the first plurality of signals 500. The plurality of signals 502 may then be provided to one or more user input devices, displays, gauges, etc. for presentation to a user.

STMC 506 and MTSC 504 may be in communication with synchronizing circuits 300, 302, respectively, to periodically reinitialize associated signal consolidation and signal restoring circuits.

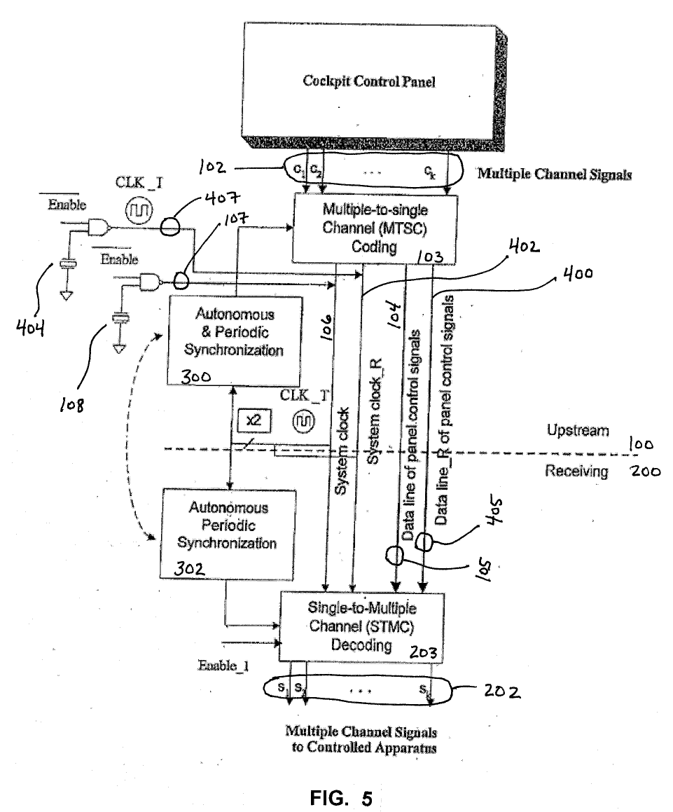

FIG. 5 illustrates a control and communications architecture 10 configured to provide redundant communications between MTSC 103 and STMC 203. Vehicle control architecture 10 may include redundant transmission mediums between MTSC 103 and STMC 203. For instance, MTSC 103 may be configured to transmit consolidated signal 104 to STMC 203 over transmission medium 105, and to transmit a redundant consolidated signal 400 to STMC 203 over redundant transmission medium 405. In an embodiment, consolidated signal 104 and redundant consolidated signal 400 are identical or substantially identical. In an embodiment, redundant transmission medium 405 may be implemented using the same transmission medium as is used for the transmission medium 105. This may, for example, take the form of multiple copper lines, or multiple fiber optic lines, each configured to transmit a redundant signal.

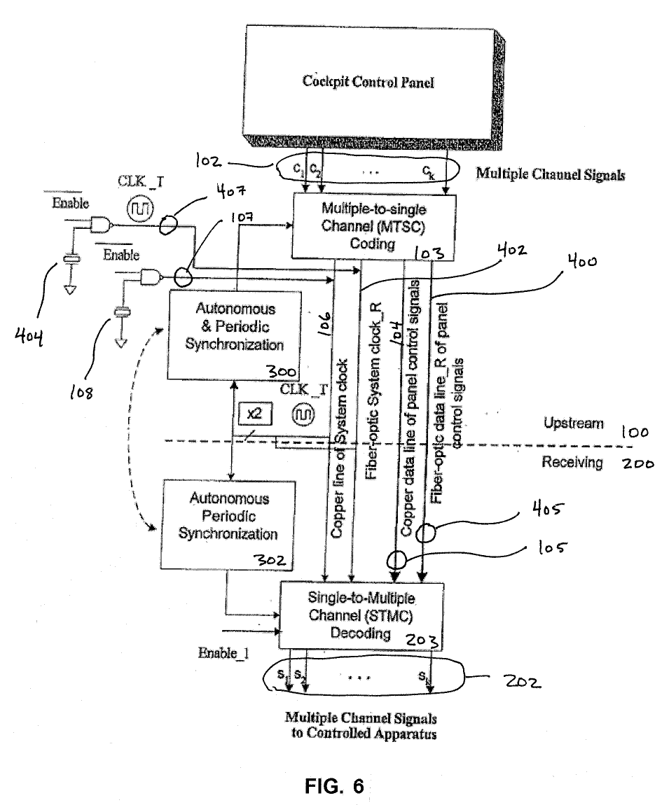

In another embodiment, as generally illustrated in FIG. 6, redundant transmission medium 405 may be a different medium than transmission medium 105. For example, transmission medium 105 may be a first medium, such as a copper wire, and redundant transmission medium 405 may be a different medium, such as a fiber optic cable. In such an embodiment, it is understood that consolidated signal 104 and redundant consolidated signal 400 may differ slightly, due to the differences in transmission mediums, though the information they convey may be substantially identical.

In one embodiment, MTSC 103 and STMC 203 may include one or more redundant circuits, such as signal receiving portions 120, input circuitry 220, consolidation circuits 122, signal restoring circuits 222, driving circuits 124, and signal output circuits 224. Additionally, or alternatively, consolidated signal 104 and redundant consolidated signal 400 may be generated by separate MTSC devices 103, and may be resolved by separate STMC devices 203. That is, transmitting portion 100 may include a first MTSC 103 for consolidated signal 104, and a second MTSC 103 for redundant consolidated signal 400, while receiving portion 200 may include a first STMC 203 for consolidated signal 104 and a second STMC 104 for redundant consolidated signal 204.

A redundant timing signal 402 may be provided, using a redundant clock signal generator 404. Redundant timing signal 402 may be transmitted over a transmission medium 407.

It is contemplated that the system may be implemented using a collection of electrical hardware components with no reliance on either software or firmware. As such, the system may be designed to blindly and orderly cycle through the plurality of input signals 102 without regard for, or analysis of, a designated priority or importance of a signal. As may be clear to one of ordinary skill in the art, this system may be implemented with regard to input signals generated by slow dynamic systems. In an embodiment, “slow dynamic systems” may refer to systems that generate digital signals or cross TTL logic levels at a frequency slower than the time necessary for the signal consolidation circuit 122 to cycle through each of the plurality of input signals 102. This avoids situations in which signals vary at a faster rate than the time necessary to cycle through the plurality of input signals 102. In an embodiment, such “slow dynamic systems” may include, for example, in an airplane context, systems requiring selective user control, (e.g., actuation of buttons, switches, levers, or throttles), systems providing visual feedback to a human user (e.g., indicator lights, dials, gauges), systems having a slow relative time constant due to required movement of physical hardware (e.g., airplane flaps, airplane landing gear, airplane doors or hatches), systems involving auxiliary sensory input not tied to operational control (e.g., door latch states, gasoline level, oil pressure, air speed, air temperature, external pressure). It is to be understood that a wide range of changes and modifications to the embodiments described above will be apparent to those skilled in the art, and are contemplated.

It is therefore intended that the foregoing detailed description be regarded as illustrative rather than limiting, and that it be understood that it is the following claims, including all equivalents, that are intended to define the spirit and scope of this invention.

What is claimed:

1. A hardware-based control and communication architecture for communicating a plurality of signals within an aircraft, the architecture comprising:
a transmitting portion including:
a signal receiving portion configured to obtain or receive a first plurality of signals;
a signal consolidation circuit;
a signal driver capable of transmitting a consolidated signal representative of the first plurality of signals from the signal consolidation circuit; and
a clock signal generator configured to provide a synchronizing timing signal having an established or fixed period;
wherein the signal consolidation circuit includes hardware logic to provide successive data transmission windows based on the established or fixed period of the synchronizing timing signal; and the consolidation circuit is configured to transmit each of the first plurality of signals in successive data transmission windows.

2. The control and communication architecture of claim 1, further comprising:
a receiving portion including:
input circuitry configured to obtain or receive the consolidated signal representative of the first plurality of signals;
a signal restoring circuit; and
a signal output portion configured to transmit a second plurality of signals representative of the consolidated signal from the signal restoring circuit;
wherein the signal restoring circuit includes hardware logic and the signal restoring circuit is configured to use the established or fixed period of the synchronizing timing signal to assemble or configure the second plurality of signals to be representative of the first plurality of signals.

3. The control and communication architecture of claim 2, wherein each of the signal consolidation circuit and the signal restoring circuit include a synchronizing circuit that periodically re-initializes the respective signal consolidation circuit and the signal restoring circuit.

4. The control and communication architecture of claim 3, wherein each synchronizing circuit provides the periodic re-initialization based upon an accumulation of an established or predetermined number of synchronizing timing signal periods.

5. The control and communication architecture of claim 1, wherein the signal driver is operative to transmit the signal through a conductive wire.

6. The control and communication architecture of claim 1, wherein the signal driver is configured to transmit the signal through a fiber-optic transmission line.

7. The control and communication architecture of claim 1, including a second communication architecture that operates in parallel with the first communication architecture to provide a redundant system.

8. The control and communication architecture of claim 1, including a second communication architecture that operates in reverse to provide bidirectional signal transmission.

9. The control and communication architecture of claim 1, wherein the timing signal has a frequency of less than about 1 MHz.

10. The control and communication architecture of claim 1, wherein the first plurality of signals comprises a plurality of digital electrical signals.

11. The control and communication architecture of claim 1, wherein the first plurality of signals comprises electrical signals generated by slow dynamic systems.

12. The control and communication architecture of claim 1, wherein at least a subset of the plurality of signals is received from an aircraft control panel.

13. A control and communication architecture for communicating a plurality of electrical signals within a vehicle, the architecture comprising:
a transmitting portion including:
an electrical signal receiving portion configured to obtain or receive a first plurality of electrical signals;
an electrical signal consolidation circuit;
a signal driver configured to transmit a consolidated signal representative of the first plurality of electrical signals from the electrical signal consolidation circuit; and
a clock signal generator configured to provide a synchronizing timing signal having an established or fixed period;
wherein the electrical signal consolidation circuit includes hardware logic to provide successive data transmission windows based on the period of the synchronizing timing signal, and wherein the electrical signal consolidation circuit is configured to transmit each of the first plurality of electrical signals in successive data transmission windows; and
a receiving portion including:
input circuitry configured to obtain or receive the consolidated signal representative of the first plurality of electrical signals;
a signal restoring circuit; and
an electrical signal output portion configured to transmit a second plurality of electrical signals representative of the consolidated signal from the signal restoring circuit;
wherein the signal restoring circuit includes hardware logic and utilizes the period of the synchronizing timing signal to assemble or configure the second plurality of electrical signals to be representative of the first plurality of electrical signals,
wherein each of the transmitting portion and the receiving portion include a synchronizing circuit that periodically re-initializes the signal consolidation circuit and the signal restoring circuit.

14. The control and communication architecture of claim 13, wherein at least one of the first plurality of electrical signals comprises a vehicle operating signal.

15. The control and communication architecture of claim 13, wherein the signal driver is operative to transmit the signal through a conductive wire.

16. The control and communication architecture of claim 13, wherein the signal driver is operative to transmit the signal through a fiber-optic transmission line.

17. The control and communication architecture of claim 13, including a second communication architecture that operates in parallel with the first communication architecture to provide a redundant system.

18. The control and communication architecture of claim 13, including a second communication architecture that operates in reverse to permit bidirectional signal transmission.

19. The control and communication architecture of claim 13, wherein the timing signal has a frequency of less than about 1 MHz.

20. The control and communication architecture of claim 13, wherein the first plurality of electrical signals comprises a plurality of digital electrical signals.

21. The control and communication architecture of claim 13, wherein the first plurality of electrical signals comprises electrical signals generated by slow dynamic systems.

22. The control and communication architecture of claim 13, wherein each synchronizing circuit bases the periodic re-initialization on the accumulation of an established or predetermined number of synchronizing timing signal periods.

23. The control and communication architecture of claim 22, wherein each synchronizing circuit receives synchronizing timing signals from a common clock signal generator.
